(19) United States
(12) Patent Application Publication
(10) Pub. No.: US 2025/0344171 A1
(43) Pub. Date: Nov. 6, 2025

(54) ADAPTIVE SIDELINK SYNCHRONIZATION FOR V2X COMMUNICATION

(71) Applicant: QUALCOMM Incorporated, San Diego, CA (US)

(72) Inventors: Shuanshuan WU, San Diego, CA (US); Shailesh PATIL, San Diego, CA (US); Kapil GULATI, Belle Mead, NJ (US); Gene Wesley MARSH, San Diego, CA (US); Tien Viet NGUYEN, Bridgewater, NJ (US); Hui GUO, Beijing (CN)

(21) Appl. No.: 18/854,040

(22) PCT Filed: May 25, 2022
(86) PCT No.: PCT/CN2022/094891

§ 371 Date: Oct. 3, 2024

(51) Int. Cl. H04W 56/00; H04W 4/44; H04W 64/00; H04W 76/20; H04W 92/18

(52) U.S. Cl. CPC H04W 56/0015; H04W 4/44; H04W 64/00; H04W 76/20; H04W 92/18

(57) ABSTRACT

This disclosure provides systems, devices, apparatus, and methods, including computer programs encoded on storage media, for communications based on sidelink synchronization. A UE may receive an indication associated with enabling or disabling a sidelink synchronization procedure of the UE, where the sidelink synchronization procedure of the UE may be enabled or disabled based on the indication. The UE may communicate with a wireless device via a sidelink communication based on whether the sidelink synchronization procedure of the UE is enabled or disabled.

### TECHNICAL FIELD

The present disclosure relates generally to communication systems, and more particularly, to communications based on sidelink synchronization.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may receive an indication associated with enabling or disabling a sidelink synchronization procedure of a user equipment (UE), where the sidelink synchronization procedure of the UE is enabled or disabled based on the indication; and communicate with a wireless device via a sidelink communication based on whether the sidelink synchronization procedure of the UE is enabled or disabled.

In another aspect of the disclosure, a method, a computer-readable medium, and an apparatus are provided. The apparatus may transmit an indication associated with enabling or disabling a sidelink synchronization procedure of a UE, where the indication is configured to trigger the enabling or disabling of the sidelink synchronization procedure of the UE; and communicate via a sidelink communication based on whether the indication triggers the enabling of the sidelink synchronization procedure of the UE or the disabling of the sidelink synchronization procedure of the UE.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 illustrates a diagram of a plurality of UEs in communication with a Global Navigation Satellite System (GNSS) synchronization source based on one or more hops.

FIG. 5 illustrates a diagram including a plurality of roadside units (RSUs) that may be deployed to assist one or more UEs in locations without direct access to a GNSS signal.

FIG. 6 is a call flow diagram illustrating communications between entities of a network.

FIG. 7 is a flowchart of a method of wireless communication at a UE.

FIG. 8 is a flowchart of a method of wireless communication at a UE.

FIG. 9 is a flowchart of a method of wireless communication at a wireless device.

FIG. 10 is a flowchart of a method of wireless communication at a wireless device.

FIG. 11 is a diagram illustrating an example of a hardware implementation for an example apparatus and/or network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

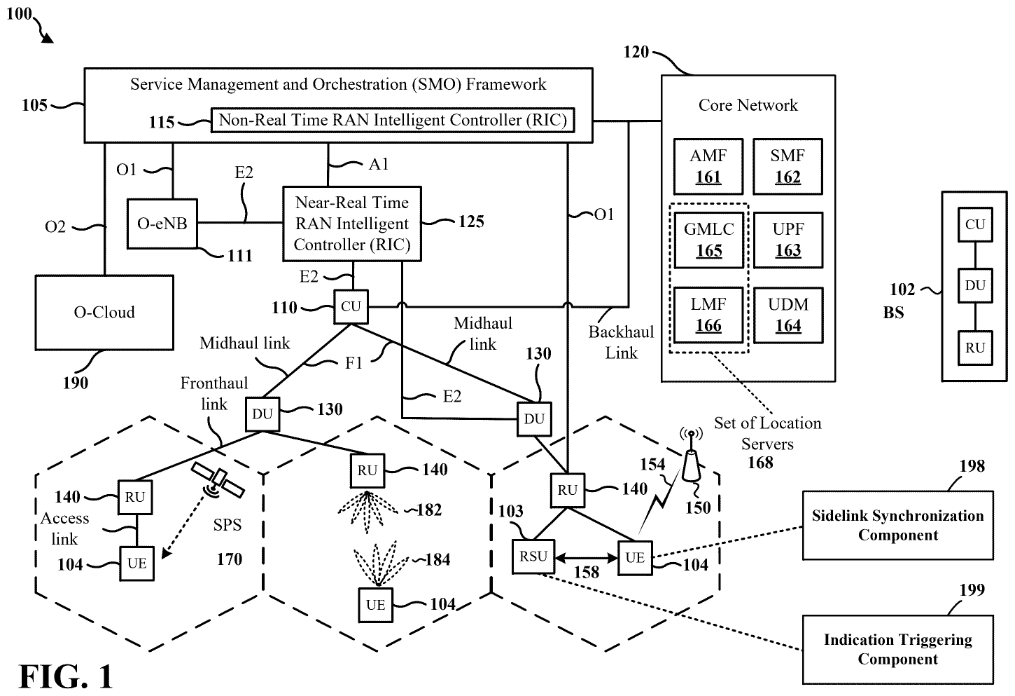

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective user equipments (UEs) 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a sidelink synchronization component 198 configured to receive an indication associated with enabling or disabling a sidelink synchronization procedure of the UE, where the sidelink synchronization procedure of the UE is enabled or disabled based on the indication; and communicate with a wireless device via a sidelink communication based on whether the sidelink synchronization procedure of the UE is enabled or disabled. In certain aspects, a UE such as a roadside unit (RSU) 103 may include an indication triggering component 199 configured to transmit an indication associated with enabling or disabling a sidelink synchronization procedure of a UE, where the indication is configured to trigger the enabling or disabling of the sidelink synchronization procedure of the UE; and communicate via a sidelink communication based on whether the indication triggers the enabling of the sidelink synchronization procedure of the UE or the disabling of the sidelink synchronization procedure of the UE. Although the following description may be focused on 5G NR, the concepts described herein may be applicable to other similar areas, such as LTE, LTE-A, CDMA, GSM, and other wireless technologies.

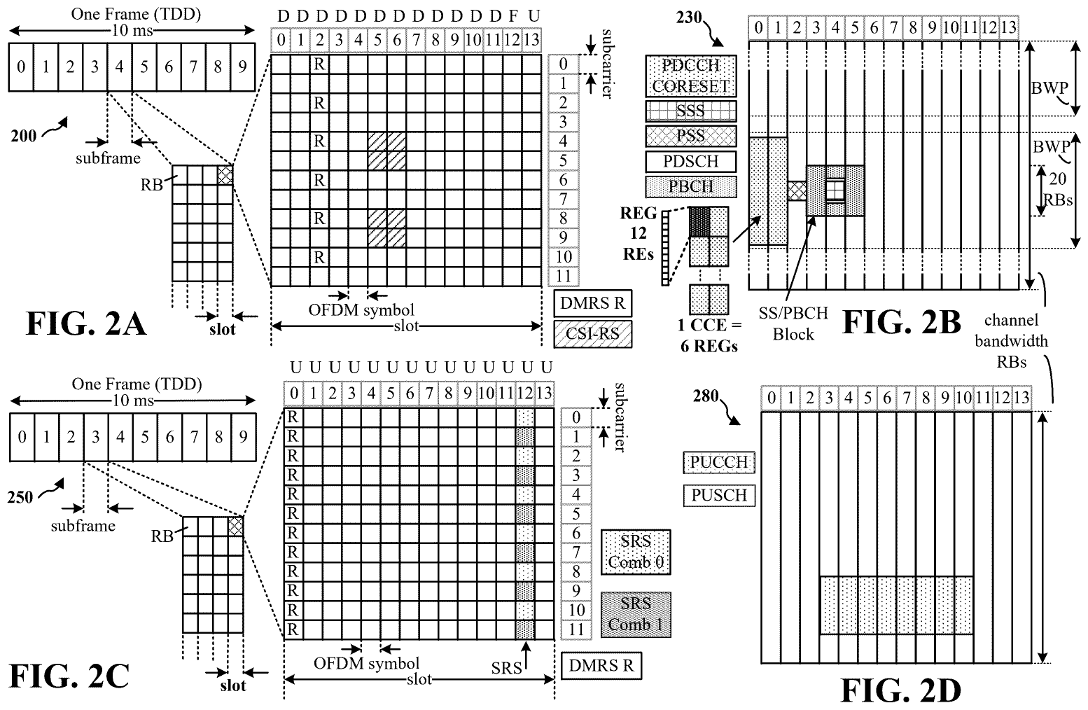

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 24*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

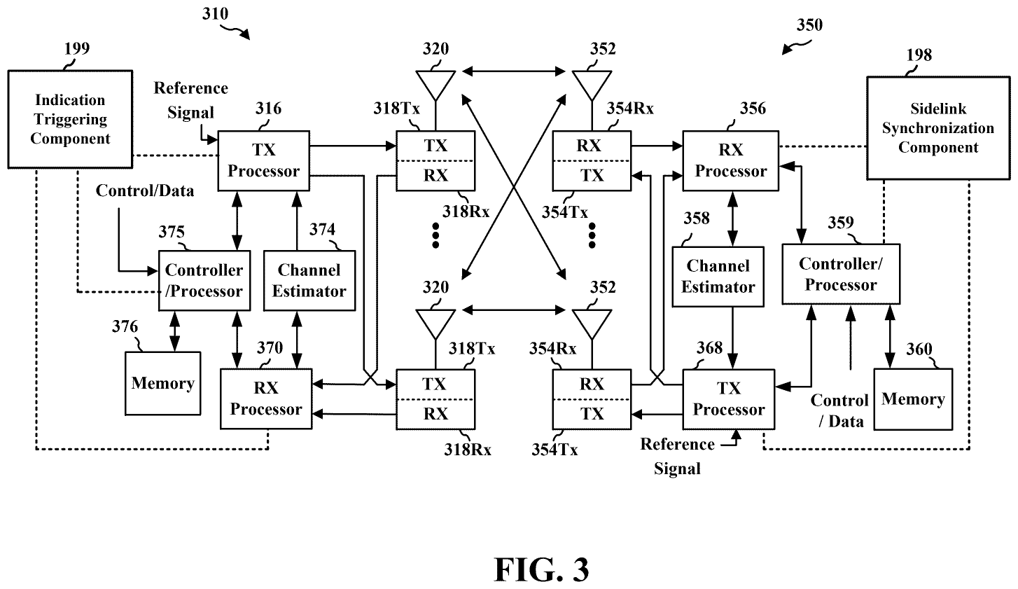

FIG. 3 is a block diagram of an RSU 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization. The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the RSU 310. These soft decisions may be based on channel estimates computed by the channel estimator 358. The soft decisions are then decoded and deinterleaved to recover the data and control signals that were originally transmitted by the RSU 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the RSU 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the RSU 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the RSU 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the sidelink synchronization component 198 of FIG. 1.

At least one of the TX processor 316, the RX processor 370, and the controller/processor 375 may be configured to perform aspects in connection with the indication triggering component 199 of FIG. 1.

Wireless communication systems may be configured to share available system resources and provide various telecommunication services (e.g., telephony, video, data, messaging, broadcasts, etc.) based on multiple-access technologies such as CDMA systems, TDMA systems, FDMA systems, OFDMA systems, SC-FDMA systems, TD-SCDMA systems, etc. that support communication with multiple users. In many cases, common protocols that facilitate communications with wireless devices are adopted in various telecommunication standards. For example, communication methods associated with eMBB, mMTC, and ultra-reliable low latency communication (URLLC) may be incorporated in the 5G NR telecommunication standard, while other aspects may be incorporated in the 4G LTE standard. As mobile broadband technologies are part of a continuous evolution, further improvements in mobile broadband remain useful to continue the progression of such technologies.

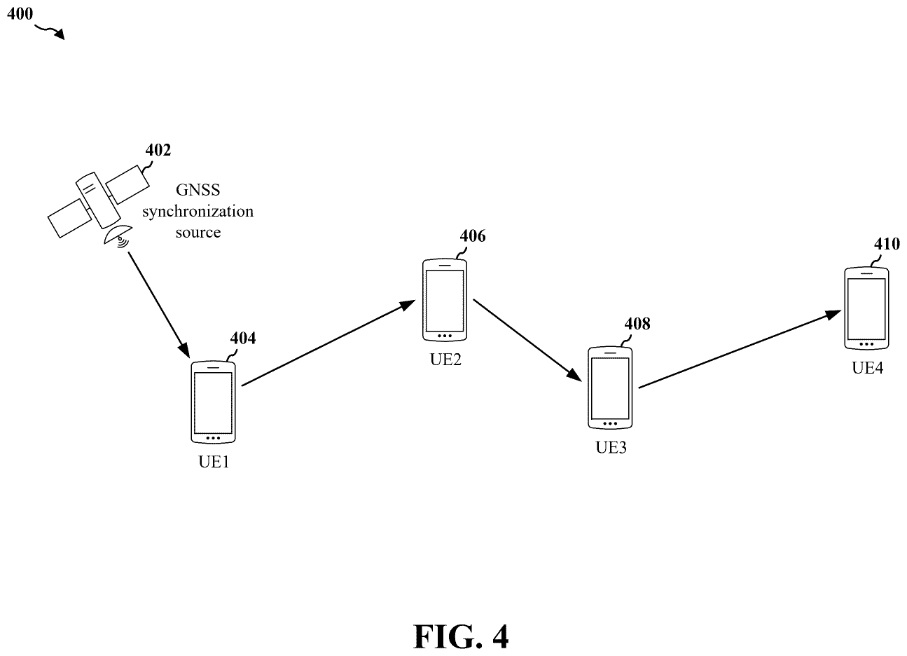

FIG. 4 illustrates a diagram 400 of a plurality of UEs in communication with a GNSS synchronization source 402 based on one or more hops. Sidelink synchronization and communication may be decoupled in sidelink systems. That is, sidelink synchronization may be performed at a different time and/or based on a different procedure than sidelink communication. Sidelink communication refers to a device-to-device (D2D) communication technique without relaying data via a network. Sidelink synchronization (i.e., a sidelink synchronization procedure) may be based on a predefined hierarchical synchronization structure, where a UE may be synchronized to a synchronization source of a higher synchronization priority. For example, a first UE 404 may be synchronized to the GNSS synchronization source 402 of a higher synchronization priority than the first UE 404. In another example, a second UE 406 may be synchronized to the first UE 404, which may be of a higher synchronization priority than the second UE 406 based on the first UE 404 being synchronized directly to the GNSS synchronization source 402 and the second UE 406 being indirectly synchronized to the GNSS synchronization source 402. A synchronization source refers to an entity that indicates timing information to one or more other devices. Thus, a GNSS synchronization sources refers a GNSS that indicates timing information to more or more other devices, such as UEs, roadside units (RSUs), etc.

A UE may transmit a sidelink synchronization signal (SLSS) and/or a sidelink synchronization signal block (S-SSB) associated with an SFN. In examples, a SLSS may also be referred to as a S-SSB, such as for NR sidelink and V2X examples. The SLSS may correspond to one or more of a sidelink primary synchronization signal (SPSS), a sidelink secondary synchronization signal (SSSS), or a physical sidelink broadcast channel (PSBCH). The SFN may be decoupled within the sidelink system. The second UE 406 may receive a SLSS from the first UE 404 and may determine a frame and/or a slot boundary for sidelink communication based on a reception timing associated with the SLSS. Based on decoupling sidelink synchronization and communication as well as an SFN type SLSS transmission, the second UE 406 that receives the SLSS from the first UE 404 may maintain a common timing for sidelink communications. Common timing may be used for one-to-many sidelink communications, such as groupcast, broadcast, etc., and may be associated with synchronization overhead and interference, such as when the plurality of UEs are configured in a distributed manner. Different UEs of the plurality of UEs may also transmit a same SLSS/S-SSB at the same time/frequency resources in some examples.

The plurality of UEs illustrated in the diagram 400 may correspond to an example hierarchical synchronization structure, such as for vehicle-to-everything (V2X) communications. The GNSS synchronization source 402 may have a higher priority than any of the plurality of UEs. Thus, the plurality of UEs may attempt to synchronize directly to the GNSS synchronization source 402 for maintaining the common timing, if a GNSS signal is available to one or more of the plurality of UEs. For example, the first UE 404 may synchronize directly to the GNSS synchronization source 402 based on reception of a GNSS signal from the GNSS synchronization source 402.

If a GNSS signal is unavailable, one or more of the plurality of UEs may synchronize to the GNSS synchronization source 402 indirectly via one or more other UEs. For example, the second UE 406 may synchronize to the GNSS synchronization source via the first UE 404 based on a second hop to the GNSS synchronization source 402. Hence, the first UE 404 may have a higher priority than the second UE 406, and the GNSS synchronization source 402 may have a higher priority than both the first UE 404 and the second UE 406. UEs that are more than two hops away from the GNSS synchronization source 402, such as a third UE 408 and a fourth UE 410, may share a same synchronization priority, which may correspond to a lower synchronization priority than the second UE 406 that is two hops from the GNSS synchronization source 402. In other examples, an increased number of hops from the GNSS synchronization source 402 may correspond to a decreased synchronization priority.

The network entities illustrated in the diagram 400 may correspond to different priority groups. For example, priority group 1 may include the GNSS synchronization source 402, which may have the highest priority among the network entities. The plurality of UEs may utilize the GNSS synchronization source 402 for timing synchronization, if a GNSS signal is available. For instance, if the first UE 404 detects a GNSS signal having a threshold signal strength, the first UE 404 may synchronize directly to the GNSS synchronization source 402. Priority group 2 may include SyncRef UEs, such as the first UE 404, that are directly synchronized to the GNSS synchronization source 402. “SyncRef” refers to a UE of a synchronization chain. SyncRef UEs may be regarded by other UEs as a reliable reference entity for synchronization when the other UEs are unable to directly synchronize to the GNSS synchronization source 402. The SyncRef UEs may transmit a SLSS on a first resource based on inCoverage=true and may have a SLSS identifier (ID)=0. “InCoverage” refers to a field of the sidelink MIB (e.g., communicated on the PSBCH) that may be used to distinguish SLSSs from different UEs. InCoverage=true indicates that a transmitter of the SLSS is in direct communication/synchronization with a GNSS or a base station (e.g., the transmitter of the SLSS is associated with a first hop of the communication chain). InCoverage=false indicates that the transmitter of the SLSS is not in direct communication/synchronization with the GNSS or the base station (e.g., the transmitter of the SLSS is associated with a second or greater hop of the communication chain). The SLSS ID may be determined based on a combination of the SPSS ID and the SSSS ID.

Priority group 3 may include UEs that directly synchronized to a priority group 2 UE. For example, the second UE 406 may be in priority group 3, as the second UE 406 is directly synchronized to the first UE 404 that is directly synchronized to the GNSS synchronization source 402. UEs included in priority group 3 may be associated with the second hop of the synchronization chain. The second UE 406 may transmit a SLSS on a second resource based on inCoverage=false and may have a SLSS ID=1. Priority group 4 may include other remaining UEs, such as the third UE 408 and the fourth UE 410, that are more than two hops from the GNSS synchronization source 402. A third or greater hop in the synchronization chain may be correspond to inCoverage=false. Priority group 4 may also include UEs having a timing that is based on a synchronization source, such as a sidelink UE that transmits a synchronization signal.

Some V2X deployments may be associated with areas that do not include GNSS coverage. For example, UEs that are located in a tunnel, underground parking, etc., may not have direct access to a GNSS signal. Accordingly, such UEs may execute other techniques for timing synchronization, such as indirectly synchronizing with the GNSS synchronization source 402 via one or more other UEs and/or transmitting a SLSS/S-SSB. In locations without direct access to a GNSS signal, a SLSS/S-SSB may be used for UEs to maintain common timing and frequency for sidelink/V2X communications.

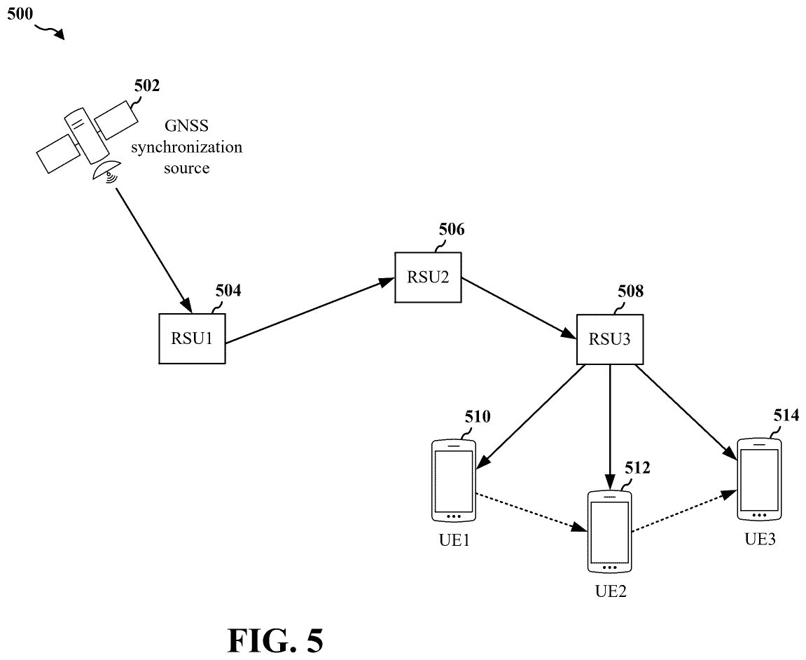

FIG. 5 illustrates a diagram 500 including a plurality of RSUs that may be deployed to assist one or more UEs in locations without direct access to a GNSS signal. RSU refers to a sidelink UE that may be mounted along a road or pedestrian passageway. An RSU may also be mounted on a vehicle or hand-carried, but operates when the vehicle or hand-carried device is stationary. An RSU may broadcast data to on-board units (OBUs) or exchange data with OBUs in a communications zone. An RSU may provide channel assignments and operating instructions to OBUs in the communications zone. A first RSU 504, a second RSU 506, and a third RSU 508, which may be synchronized to a GNSS synchronization source 502, may be deployed to assist V2X communications in tunnels, underground parking areas, etc. RSUs deployed in tunnels or other shielded locations may serve as a synchronization source to UEs positioned at such locations. For example, the third RSU 508 may serve as a synchronization source to a first UE 510, a second UE 512, and/or a third UE 514 that may not have direct access to a GNSS signal. Hence, the RSUs (e.g., the third RSU 508) may have a higher synchronization priority than the first UE 510, the second UE 512, and the third UE 514 (e.g., V2X devices), but may have a lower synchronization priority than the GNSS synchronization source 502. The RSUs may be synchronized to the GNSS synchronization source 502, and the sidelink UEs/V2X devices may be synchronized to the RSUs.

The first RSU 504 may be directly synchronized to the GNSS synchronization source 502 (e.g., outside a tunnel) and may relay timing information to one or more other RSUs, such as the second RSU 506 and the third RSU 508 (e.g., located inside the tunnel) via one or more hops. The third RSU 508 may transmit a SLSS/S-SSB to vehicle UEs, such as the first UE 510, the second UE 512, and the third UE 514, that do not have direct access to a GNSS connection. The vehicle UEs may be synchronized to the RSU based on detecting the SLSS/S-SSB.

The vehicle UEs may or may not have the capability to transmit a SLSS/S-SSB, which may allow a vehicle UE to serve as a synchronization source. For locations that include RSU deployments, each vehicle UE may synchronize to an RSU, rather than to another sidelink/vehicle UE, which may reduce a number of hops in the synchronization chain. For example, the first UE 510, the second UE 512, and the third UE 514 may synchronize to the third RSU 508, rather than to each other. For locations that do not include RSUs, sidelink/vehicle UEs may serve as a synchronization source, which may be used to synchronize a group of one or more other UEs. For example, the second UE 512 may synchronize to the first UE 510, and the third UE 514 may synchronize to the second UE 512. RSUs deployed by roadway operators may be regarded as sidelink UEs. Thus, in order to prioritize the RSUs over vehicle UEs, the RSUs may have to be distinguished from vehicle UEs, such as OBUs.

In a first example, an RSU such as the third RSU 508 may be deployed as a synchronization source, where the RSU may be either directly or indirectly synchronized to the GNSS synchronization source 502. Sidelink UEs such as the first UE 510, the second UE 512, and the third UE 514 may be synchronized to the third RSU 508 to maintain common timing. In such cases, sidelink/vehicle UEs may refrain from transmitting a SLSS/S-SSB, so that the third RSU 508 does not inadvertently select the sidelink/vehicle UEs as the synchronization source. Otherwise, the synchronization chain may include additional/unnecessary hops and/or may accumulate a timing/frequency error associated with the additional/unnecessary hops. In a second example without an RSU deployed as the synchronization source, the sidelink/vehicle UE may transmit a SLSS/S-SSB, so that other sidelink/vehicle UEs in range of the transmission may maintain common timing for communicating with each other. For example, the first UE 510 may transmit a SLSS/S-SSB, which may be received by the second UE 512 for synchronization with the first UE 510.

Sidelink UEs may have to operate according to different procedures based on whether an RSU, such as the third RSU 508, is deployed as a synchronization source or whether the sidelink UEs transmit a SLSS/S-SSB. In the first example, the sidelink UEs may switch off/refrain from transmitting a SLSS/S-SSB, so that other UEs do not select the transmitting UE as the synchronization source. With the sidelink UEs refraining from transmissions of the SLSS/S-SSB, synchronization signals received by the sidelink UEs may correspond to signals transmitted by an RSU, which may be further synchronized, either directly or indirectly, with the GNSS synchronization source 502. The GNSS synchronization source 502 may be regarded as having more stable timing information than timing information associated with transmissions of the SLSS/S-SSB by the sidelink UEs. In the second example, the sidelink UEs may be synchronized based on transmission/detection of the SLSS/S-SSB. The sidelink UEs may transmit/detect synchronization information based on a capability of the sidelink UEs and/or based on a pre-configuration for SLSS/S-SSB resources.

One or more techniques may be implemented to switch on/off the UE transmissions of the SLSS/S-SSB. For example, RSUs may be configured to transmit OTA signals indicative of the RSUs being the synchronization source for the sidelink UEs. An OTA signal transmitted by an RSU may trigger the sidelink UE to deactivate SLSS/S-SSB transmission and reception. For example, the third RSU 508 may transmit an OTA signal that triggers the first UE 510, the second UE 512, and the third UE 514 to switch off SLSS/S-SSB transmissions. After a certain period of time without receiving an OTA signal from an RSU, the first UE 510, the second UE 512, and the third UE 514 may again activate SLSS/S-SSB transmission and reception procedures. The OTA signal may be associated with an upper layer signal or a MAC control element (CE) (MAC-CE) included in a sidelink PSSCH transmission of the RSU.

In further configurations, activating or deactivating SLSS/S-SSB transmission and reception for sidelink synchronization may be based on a location of the sidelink UEs. For example, the sidelink UEs may be preconfigured to deactivate SLSS/S-SSB transmission and reception in locations associated with tunnels, underground parking areas, etc., but may be preconfigured to activate SLSS/S-SSB transmission and reception in other locations. In yet a further configuration, the sidelink UEs may be configured to deactivate SLSS/S-SSB, if the sidelink UEs detect that they are located within a certain proximity to an RSU. For example, the first UE 510 may detect a SLSS ID indicative of a nearby RSU, such as the third RSU 508, which may trigger the first UE 510 to deactivate SLSS/S-SSB transmission and reception.

An OTA signal transmitted by the third RSU 508 for triggering activation/deactivation of SLSS/S-SSB transmission and reception may include a field indicative of enabling or disabling synchronization by the sidelink UEs. The OTA signal may correspond to a V2X message transmitted by the third RSU 508. In locations, such as tunnels or underground parking areas, the third RSU 508 may be deployed as a synchronization source for the first UE 510, the second UE 512, and the third UE 514 by transmitting the SLSS/S-SSB for the sidelink UEs. The first RSU 504, the second RSU 506, and the third RSU 508 may be configured/pre-configured to transmit OTA signals that enable/disable SLSS/S-SSB transmission and reception by the sidelink UEs.

SLSS/S-SSB transmission and reception may be enabled or disabled based on an RSU timing source. The first RSU 504, the second RSU 506, and the third RSU 508 may be configured to transmit OTA signals to disable SLSS/S-SSB transmission by the sidelink UE, if the RSUs derive timing information directly or indirectly from the GNSS synchronization source 502. The RSUs may also be configured to transmit the OTA signals to enable SLSS/S-SSB transmission by the sidelink UEs, if the RSUs do not derive timing information directly or indirectly from the GNSS synchronization source 502. Alternatively, the RSUs may be configured to refrain from transmitting the OTA signals, if the RSUs do not derive timing information directly or indirectly from the GNSS synchronization source 502.

In further configurations, the RSUs may be configured to transmit the OTA signals to enable/disable SLSS/S-SSB transmission and reception by the sidelink UEs based on a pre-configuration associated with RSU deployment. The RSUs may be configured to transmit the OTA signals regardless of whether the sidelink UEs are disabled or enabled for SLSS/S-SSB transmission and reception. An absence of OTA signals over a certain period of time may indicate that the sidelink UEs are to be enabled for SLSS/S-SSB transmission and reception. A sidelink UE that receives the OTA signal from the third RSU 508 may operate based on the OTA signal (e.g., disable SLSS/S-SSB transmission if the OTA signal is received). In cases where a GNSS signal may not be directly received by a sidelink UE from the GNSS synchronization source 502, the RSUs (e.g., the third RSU 508) may be able to directly or indirectly inherit GNSS timing from the GNSS synchronization source 502. Synchronization techniques with RSU deployments may be improved based on the sidelink UEs (e.g., that do not receive GNSS signals) refraining from performing SLSS/S-SSB transmissions, so that other sidelink UEs may receive and follow the timing information indicated from the RSUs.

OTA signals transmitted by RSUs, such as the third RSU 508, for triggering activation/deactivation of UE synchronization procedures may correspond to a SLSS/S-SSB transmitted by the third RSU 508. The SLSS/S-SSB transmitted by the third RSU 508 may indicate/trigger the enabling/disabling of SLSS/S-SSB transmission and reception by the sidelink UEs. One or more reserved bits may be included in a sidelink MIB to indicate the disabling of SLSS/S-SSB transmission. The SLSS/S-SSB transmitted by the sidelink UEs may be disabled upon reception of SLSS/S-SSB with a disabling indication in the reserved bits of the sidelink MIB. The enabling/disabling of the SLSS/S-SSB transmission and reception by the sidelink UEs may also be indicated/implied based on a SLSS/S-SSB transmission resource. For example, the SLSS/S-SSB transmission by the third RSU 508 may be transmitted in a designated slot/subframe, such as one or more reserved subframes. If the SLSS/S-SSB is detected in one or more designated subframes, the sidelink UEs may not transmit the SLSS/S-SSB.

In the absence of a detected SLSS/S-SSB from the RSUs, the sidelink UEs may perform sidelink synchronization procedures. For example, the first UE 510 may transmit the SLSS/S-SSB to provide common timing information for other sidelink UEs, such as the second UE 512 and the third UE 514. Alternatively, the first UE 510 may not transmit a SLSS/S-SSB if the first UE 510 detects a SLSS/S-SSB from the third RSU 508 indicative of disabling the SLSS/S-SSB transmission. The reserved bits indicative of disabling the SLSS/S-SSB may correspond to a pre-configuration. For example, the third RSU 508 may be pre-configured to use the reserved bits to indicate the disabling of the SLSS/S-SSB transmissions by the sidelink UEs. In cases where a GNSS signal may not be directly received by the sidelink UEs from the GNSS synchronization source 502, the RSUs (e.g., the third RSU 508) may be able to directly or indirectly inherit GNSS timing from the GNSS synchronization source 502. Synchronization techniques with RSU deployments may be improved based on the sidelink UEs (e.g., that do not receive GNSS signals) refraining from performing SLSS/S-SSB transmissions, so that other sidelink UEs may receive and follow the timing information indicated from the RSUs.

Deactivation of SLSS/S-SSB transmission by the sidelink UEs may be based on a location of the sidelink UEs. In some examples, the location may correspond to an approximate location of the sidelink UEs. The location information may be configured/pre-configured to the first UE 510, the second UE 512, and the third UE 514, which may be V2X UEs. The sidelink UEs may switch off SLSS/S-SSB transmission based on the location of the sidelink UEs. Locations where the sidelink UEs switch off SLSS/S-SSB transmission may correspond to locations where one or more RSUs may be deployed as a synchronization source for the sidelink UE. For example, the first UE 510 may switch off SLSS/S-SSB transmission, if the first UE 510 is at a configured/pre-configured location, such that the first UE 510 may monitor for/detect a SLSS/S-SSB from an RSU, such as the first RSU 504, the second RSU 506, or the third RSU 508. The locations may be indicated based on zones and/or zone IDs that may be pre-configured to the sidelink UEs. The first UE 510, the second UE 512, and the third UE 514 may have reduced access to GNSS signals in locations, such as tunnels or underground parking areas. Hence, the configured/pre-configured locations may not correspond to precise coordinates, but may instead corresponds to approximated areas where the sidelink UEs have reduced access to GNSS signals from the GNSS synchronization source 502. For example, the locations may be based on historically available GNSS signal information, such that the first UE 510, the second UE 512, and the third UE 514 may infer that SLSS/S-SSB transmissions should be disabled at such locations. Accordingly, SLSS/S-SSB transmissions by the sidelink UEs may be switched on by default, but the sidelink UEs may be triggered to switch off the SLSS/S-SSB transmissions based on the sidelink UEs being at a configured/pre-configured location.

Activation of SLSS/S-SSB reception by the sidelink UEs may also be based on the location of the sidelink UEs. Locations for switching on the SLSS/S-SSB reception may correspond to locations where the sidelink UE may have reduced access to GNSS signals from the GNSS synchronization source 502, such as tunnels or underground parking areas. The configured/pre-configured locations may not correspond to precise coordinates, but may instead corresponds to approximated areas where the sidelink UEs may have reduced access to GNSS signals from the GNSS synchronization source 502. For example, the locations may be based on historically available GNSS signal information, such that the first UE 510, the second UE 512, and the third UE 514 may infer that SLSS/S-SSB reception should be enabled at such locations. Accordingly, SLSS/S-SSB reception from the RSUs may be switched off by default, but the sidelink UEs may be triggered to switch on SLSS/S-SSB reception from the RSUs based on the sidelink UE being at a configured/pre-configured location. Such techniques may improve V2X performance.

The sidelink UEs may also be configured to deactivate SLSS/S-SSB transmissions, if the sidelink UEs are located within proximity of an RSU. For example, the first UE 510 may correspond to an OBU that detects a nearby RSU, such as the third RSU 508, and deactivates SLSS/S-SSB transmission by the first UE 510. The SLSS ID used by the third RSU 508 may correspond to a designated ID indicative of the third RSU 508. If the first UE 510 detects a SLSS transmitted by the second UE 512 or the third UE 514 (e.g., based on inCoverage=false, SLSS ID=0), the first UE 510 may transmit a SLSS/S-SSB based on inCoverage=false, SLSS ID=168 or 336. The SLSS ID may correspond to a value that is computed from the SPSS and/or SSSS sequence IDs. For example, 168 may correspond to an LTE sidelink procedure and 336 may correspond to NR sidelink procedure. If the third RSU 508 detects a SLSS transmitted by another UE, which may correspond to another RSU, based on inCoverage=false, SLSS ID=0, the third RSU 508 may transmit the SLSS/S-SSB based on inCoverage=false, SLSS ID=168+X or 336+X. An example implementation may correspond to X=2. The SLSS ID may be configured/pre-configured to the sidelink UEs and the RSUs. For example, the third RSU 508 may be configured/pre-configured based on 168+X or 336+X and the first UE 510 may be configured/pre-configured based on 168 or 336. If the first UE 510 is configured/pre-configured based on 168 or 336, the first UE 510 may not transmit the SLSS based on detection of a SLSS with a SLSS ID of 168+X or 336+X. That is, detection of a SLSS with a SLSS ID of 168+X or 336+X may be indicative of the third RSU 508 and may cause the first UE 510 to refrain from transmitting a SLSS based on the RSU timing associated with the third RSU 508.

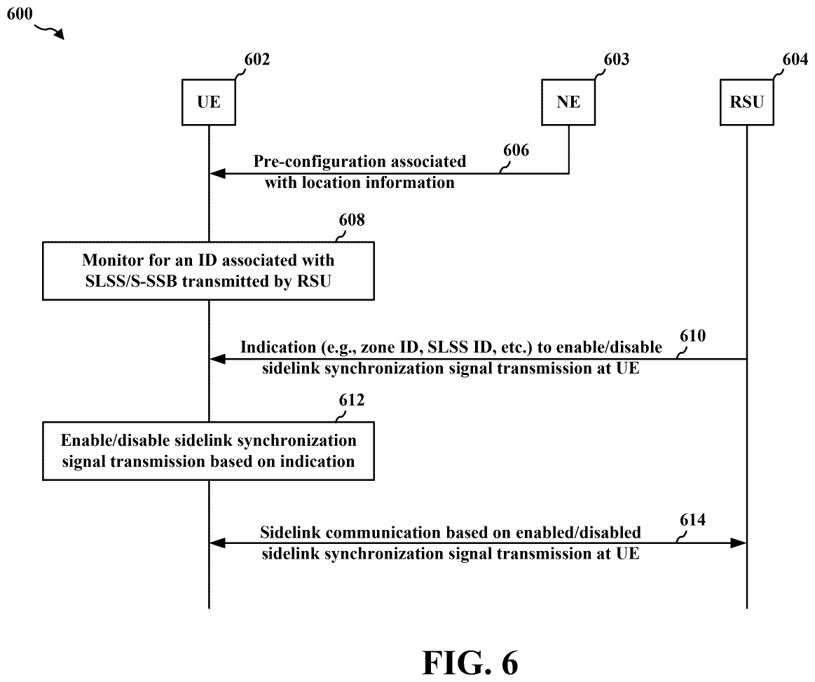

FIG. 6 is a call flow diagram 600 illustrating communications between a UE 602, a network entity 603, and an RSU 604. The network entity 603 may correspond to a base station or an entity at a base station, such as a CU, a DU, an RU, etc. At 606, the UE 602 may receive a pre-configuration from the network entity 603 associated with location information. The location information may be indicative of locations where the UE 602 may enable/disable SLSS/S-SSB transmissions (e.g., based on whether another UE, such as the RSU 604, serves as a synchronization source for the UE 602).

At 608, the UE 602 may monitor for an ID associated with a SLSS/S-SSB transmitted by the RSU 608. For example, a SLSS ID may indicate to the UE 602 that the RSU 604 may serve as a synchronization source for the UE 602, such that the UE 602 may disable SLSS/S-SSB synchronization transmissions. At 610, the UE 602 may receive an indication from the RSU 604 to enable/disable sidelink synchronization signal transmission at the UE 602. If the UE 602 detects a SLSS, the UE 602 may transmit another SLSS as a syncRef UE, if a certain RSRP threshold is satisfied. Based on the indication received, at 610, from the RSU 604, the UE 602 may not transmit the SLSS, if the RSU 604 transmits an indication for the UE 602 to disable SLSS transmission. That is, the UE 602 may not be a syncRef UE if SLSS transmission is disabled. In examples, the indication received, at 610, by the UE 602 may correspond to a zone ID indicative of a location that the UE may enable/disable sidelink synchronization signal transmission. In further examples, the indication received, at 610, from the RSU 604 may correspond to a SLSS ID that indicates the RSU 604 is available for sidelink synchronization signal transmission of the UE 602.

At 612, the UE 602 may enable/disable sidelink synchronization signal transmission based on the indication received, at 610, from the RSU 604. For example, if the indication received, at 610, corresponds to a zone ID indicative of a location where the RSU 604 serves as a synchronization source, the UE 602 may disable synchronization procedures. At 614, the UE 602 may communicate with the RSU 604 based on the enabled/disabled sidelink synchronization signal transmission at the UE 602. That is, the UE 602 may disable SLSS/S-SSB transmission and synchronize with the RSU 604 based on a SLSS/S-SSB transmission of the RSU 604 to communicate, at 614, with the RSU 604.

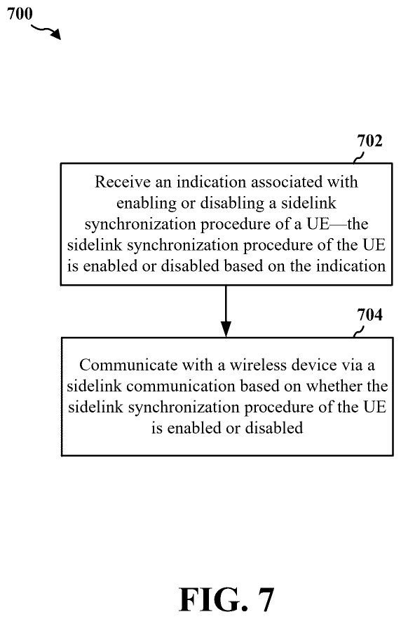

FIG. 7 is a flowchart 700 of a method of wireless communication. The method may be performed by a UE (e.g., the UE 104, 350, 404-410, 510-514, 602, the apparatus 1104, etc.), which may include the memory 360 and which may correspond to the entire UE 104, 350, 404-410, 510-514, 602 or apparatus 1104, or a component of the UE 104, 350, 404-410, 510-514, 602 or the apparatus 1104, such as the TX processor 368, the RX processor 356, the controller/processor 359, the cellular baseband processor 1124, and/or the application processor 1106.

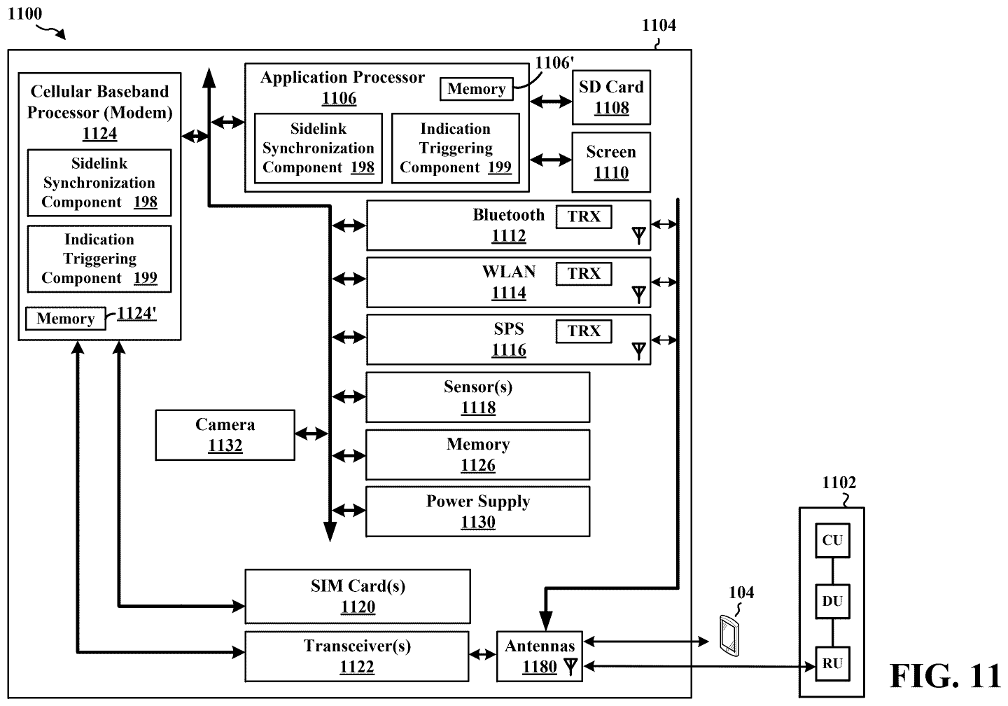

At 702, the UE may receive an indication associated with enabling or disabling a sidelink synchronization procedure of a UE—the sidelink synchronization procedure of the UE is enabled or disabled based on the indication. For example, referring to FIG. 6, the UE 602 may receive, at 610, an indication to enable/disable sidelink synchronization at the UE 602. In examples, the indication may correspond to a zone ID, a SLSS ID, etc. Sidelink synchronization by the UE 602 may be enabled/disabled, at 612, based on receiving, at 610, the indication from the RSU 604. The reception, at 702, may be performed by the sidelink synchronization component 198 of the apparatus 1104 in FIG. 11.

At 704 the UE may communicate with a wireless device via a sidelink communication based on whether the sidelink synchronization procedure of the UE is enabled or disabled. For example, referring to FIG. 6, the UE 602 may communicate, at 614, with the RSU 604 via a sidelink communication based on the enabled/disabled sidelink synchronization at the UE 602. The communication, at 704, may be performed by the sidelink synchronization component 198 of the apparatus 1104 in FIG. 11.

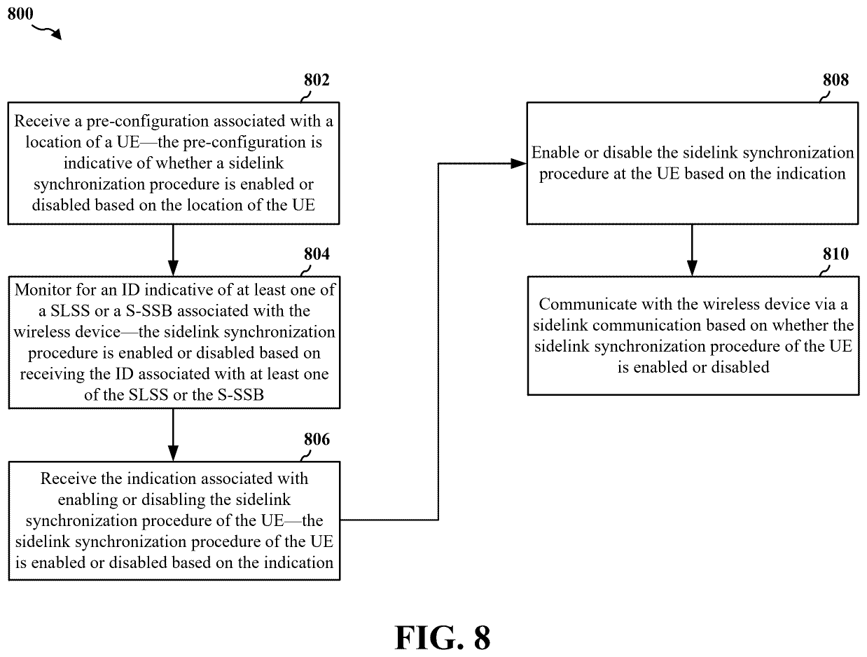

FIG. 8 is a flowchart 800 of a method of wireless communication. The method may be performed by a UE (e.g., the UE 104, 350, 404-410, 510-514, 602, the apparatus 1104, etc.), which may include the memory 360 and which may correspond to the entire UE 104, 350, 404-410, 510-514, 602 or apparatus 1104, or a component of the UE 104, 350, 404-410, 510-514, 602 or the apparatus 1104, such as the TX processor 368, the RX processor 356, the controller/processor 359, the cellular baseband processor 1124, and/or the application processor 1106.

At 802, the UE may receive a pre-configuration associated with a location of a UE—the pre-configuration is indicative of whether a sidelink synchronization procedure is enabled or disabled based on the location of the UE. For example, referring to FIG. 6, the UE 602 may receive, at 606, a pre-configuration from the network entity 603 associated with location information indicative of locations where the UE 602 may enable/disable sidelink synchronization. The reception, at 802, may be performed by the sidelink synchronization component 198 of the apparatus 1104 in FIG. 11.

At 804, the UE may monitor for an ID indicative of at least one of a SLSS or a S-SSB associated with the wireless device—the sidelink synchronization procedure is enabled or disabled based on receiving the ID associated with at least one of the SLSS or the S-SSB. For example, referring to FIG. 6, the UE 602 may monitor, at 608, for an ID associated with a SLSS/S-SSB transmitted by the RSU 604. Sidelink synchronization by the UE 602 may be enabled/disabled, at 612, based on receiving, at 610, the ID from the RSU 604. The monitoring, at 804, may be performed by the sidelink synchronization component 198 of the apparatus 1104 in FIG. 11.

At 806, the UE may receive the indication associated with enabling or disabling the sidelink synchronization procedure of the UE—the sidelink synchronization procedure of the UE is enabled or disabled based on the indication. For example, referring to FIG. 6, the UE 602 may receive, at 610, an indication to enable/disable sidelink synchronization at the UE 602. In examples, the indication may correspond to a zone ID, a SLSS ID, etc. Sidelink synchronization by the UE 602 may be enabled/disabled, at 612, based on receiving, at 610, the indication from the RSU 604. The reception, at 806, may be performed by the sidelink synchronization component 198 of the apparatus 1104 in FIG. 11.

At 808, the UE may enable or disable the sidelink synchronization procedure at the UE based on the indication. For example, referring to FIG. 6, the UE 602 may enable/disable, at 612, sidelink synchronization at the UE 602 based on receiving, at 610, the indication from the RSU 604. The enabling/disabling, at 808, may be performed by the sidelink synchronization component 198 of the apparatus 1104 in FIG. 11.

At 810, the UE may communicate with the wireless device via a sidelink communication based on whether the sidelink synchronization procedure of the UE is enabled or disabled. For example, referring to FIG. 6, the UE 602 may communicate, at 614, with the RSU 604 via a sidelink communication based on the enabled/disabled sidelink synchronization at the UE 602. The communication, at 810, may be performed by the sidelink synchronization component 198 of the apparatus 1104 in FIG. 11.

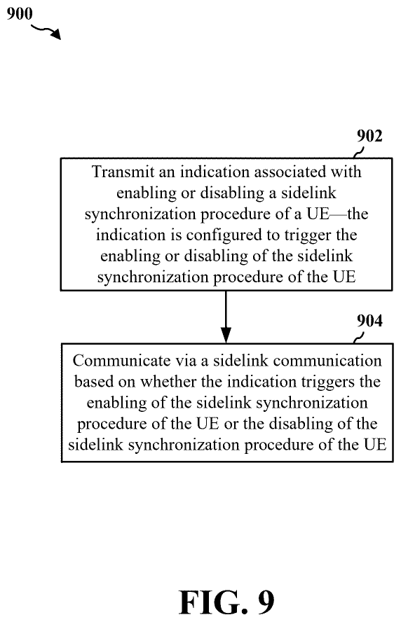

FIG. 9 is a flowchart 900 of a method of wireless communication. The method may be performed by a wireless device, such as an RSU (e.g., the RSU 103, 310, 504-508, 604, the apparatus, 1104, etc.), which may include the memory 376 and which may correspond to the entire RSU 103, 310, 504-508, 604 or a component of the RSU 103, 310, 504-508, 604, such as the TX processor 316, the RX processor 370, and/or the controller/processor 375.

At 902, the wireless device may transmit an indication associated with enabling or disabling a sidelink synchronization procedure of a UE—the indication is configured to trigger the enabling or disabling of the sidelink synchronization procedure of the UE. For example, referring to FIG. 6, the RSU 604 may transmit, at 610, an indication to the UE 602 to enable/disable sidelink synchronization at the UE 602. In examples, the indication may correspond to a zone ID, a SLSS ID, etc. The indication transmitted, at 610, to the UE 602 may trigger enabling/disabling, at 612, of the sidelink synchronization. The transmission, at 902, may be performed by the indication triggering component 199 of the apparatus 1104 in FIG. 11.

At 904, the wireless device may communicate via a sidelink communication based on whether the indication triggers the enabling of the sidelink synchronization procedure of the UE or the disabling of the sidelink synchronization procedure of the UE. For example, referring to FIG. 6, the RSU 604 may communicate, at 614, with the UE 602 via a sidelink communication based on whether the indication transmitted, at 610, enabled/disabled sidelink synchronization at the UE 602. The communication, at 904, may be performed by the indication triggering component 199 of the apparatus 1104 in FIG. 11.

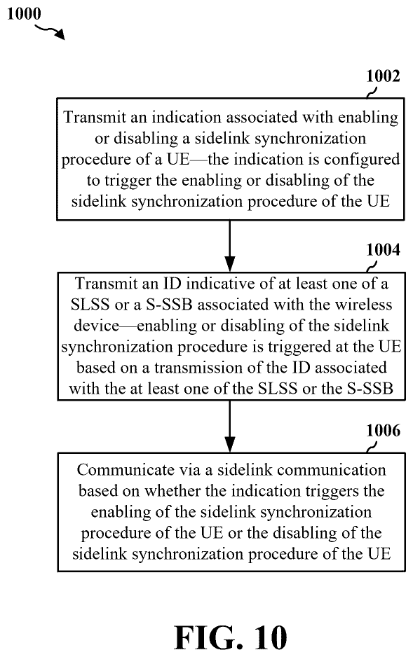

FIG. 10 is a flowchart 1000 of a method of wireless communication. The method may be performed by a wireless device, such as an RSU (e.g., the RSU 103, 310, 504-508, 604, the apparatus, 1104, etc.), which may include the memory 376 and which may correspond to the entire RSU 103, 310, 504-508, 604 or a component of the RSU 103, 310, 504-508, 604, such as the TX processor 316, the RX processor 370, and/or the controller/processor 375.

At 1002, the wireless device may transmit an indication associated with enabling or disabling a sidelink synchronization procedure of a UE—the indication is configured to trigger the enabling or disabling of the sidelink synchronization procedure of the UE. For example, referring to FIG. 6, the RSU 604 may transmit, at 610, an indication to the UE 602 to enable/disable sidelink synchronization at the UE 602. In examples, the indication may correspond to a zone ID, a SLSS ID, etc. The indication transmitted, at 610, to the UE 602 may trigger enabling/disabling, at 612, of the sidelink synchronization. The transmission, at 1002, may be performed by the indication triggering component 199 of the apparatus 1104 in FIG. 11.

At 1004, the wireless device may transmit an ID indicative of at least one of a SLSS or a S-SSB associated with the wireless device-enabling or disabling of the sidelink synchronization procedure is triggered at the UE based on a transmission of the ID associated with the at least one of the SLSS or the S-SSB. For example, referring to FIG. 6, the RSU 604 may transmit, at 610, an ID to the UE 602, which may trigger the enabling/disabling, at 612, of the sidelink synchronization at the UE 602. The transmission, at 1004, may be performed by the indication triggering component 199 of the apparatus 1104 in FIG. 11.

At 1006, the wireless device may communicate via a sidelink communication based on whether the indication triggers the enabling of the sidelink synchronization procedure of the UE or the disabling of the sidelink synchronization procedure of the UE. For example, referring to FIG. 6, the RSU 604 may communicate, at 614, with the UE 602 via a sidelink communication based on whether the indication transmitted, at 610, enabled/disabled sidelink synchronization at the UE 602. The communication, at 1006, may be performed by the indication triggering component 199 of the apparatus 1104 in FIG. 11.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include a cellular baseband processor 1124 (also referred to as a modem) coupled to one or more transceivers 1122 (e.g., cellular RF transceiver). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional modules of memory 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor 1124 communicates through the transceiver(s) 1122 via one or more antennas 1180 with the UE 104 and/or with an RU associated with a network entity 1102. The cellular baseband processor 1124 and the application processor 1106 may each include a computer-readable medium/memory 1124′, 1106′, respectively. The additional modules of memory 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see 350 of FIG. 3) and include the additional modules of the apparatus 1104.

As discussed supra, the sidelink synchronization component 198 is configured to receive an indication associated with enabling or disabling a sidelink synchronization procedure of the UE, where the sidelink synchronization procedure of the UE is enabled or disabled based on the indication; and communicate with a wireless device via a sidelink communication based on whether the sidelink synchronization procedure of the UE is enabled or disabled. The sidelink synchronization component 198 may be within the cellular baseband processor 1124, the application processor 1106, or both the cellular baseband processor 1124 and the application processor 1106. The sidelink synchronization component 198 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 1104 may include a variety of components configured for various functions. In one configuration, the apparatus 1104, and in particular the cellular baseband processor 1124 and/or the application processor 1106, includes means for receiving an indication associated with enabling or disabling a sidelink synchronization procedure of the UE, where the sidelink synchronization procedure of the UE is enabled or disabled based on the indication. The apparatus 1104 further includes means for communicating with a wireless device via a sidelink communication based on whether the sidelink synchronization procedure of the UE is enabled or disabled. The apparatus 1104 further includes means for enabling the sidelink synchronization procedure at the UE. The apparatus 1104 further includes means for disabling the sidelink synchronization procedure at the UE based on the indication. The apparatus 1104 further includes means for receiving a pre-configuration associated with the location of the UE, where the pre-configuration is indicative of whether the sidelink synchronization procedure is enabled or disabled based on the location of the UE. The apparatus 1104 further includes means for monitoring for an ID indicative of at least one of a SLSS or a S-SSB associated with the wireless device, where the sidelink synchronization procedure is enabled or disabled based on receiving the ID associated with at least one of the SLSS or the S-SSB.

The means may be the sidelink synchronization component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

As discussed supra, the indication triggering component 199 is configured to transmit an indication associated with enabling or disabling a sidelink synchronization procedure of a UE, where the indication is configured to trigger the enabling or disabling of the sidelink synchronization procedure of the UE; and communicate via a sidelink communication based on whether the indication triggers the enabling of the sidelink synchronization procedure of the UE or the disabling of the sidelink synchronization procedure of the UE. The indication triggering component 199 may be within the cellular baseband processor 1124, the application processor 1106, or both the cellular baseband processor 1124 and the application processor 1106. The indication triggering component 199 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 1104 may include a variety of components configured for various functions. In one configuration, the apparatus 1104, and in particular the cellular baseband processor 1124 and/or the application processor 1106, includes means for transmitting an indication associated with enabling or disabling a sidelink synchronization procedure of a UE, where the indication is configured to trigger the enabling or disabling of the sidelink synchronization procedure of the UE. The apparatus 1104 further includes means for communicating via a sidelink communication based on whether the indication triggers the enabling of the sidelink synchronization procedure of the UE or the disabling of the sidelink synchronization procedure of the UE. The apparatus 1104 further includes means for transmitting an ID indicative of at least one of a SLSS or a S-SSB associated with the wireless device, where enabling or disabling of the sidelink synchronization procedure is triggered at the UE based on a transmission of the ID associated with the at least one of the SLSS or the S-SSB.

The means may be the indication triggering component 199 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: receiving an indication associated with enabling or disabling a sidelink synchronization procedure of the UE, where the sidelink synchronization procedure of the UE is enabled or disabled based on the indication; and communicating with a wireless device via a sidelink communication based on whether the sidelink synchronization procedure of the UE is enabled or disabled.

Aspect 2 may be combined with aspect 1 and further includes enabling the sidelink synchronization procedure at the UE or disabling the sidelink synchronization procedure at the UE based on the indication.

Aspect 3 may be combined with any of aspects 1-2 and includes that the sidelink synchronization procedure corresponds to transmission of at least one of a SLSS or a S-SSB from the UE.

Aspect 4 may be combined with any of aspects 1-3 and includes that enabling the sidelink synchronization procedure further includes switching the sidelink synchronization procedure from disabled to enabled based on the indication, where disabling the sidelink synchronization procedure further includes switching the sidelink synchronization procedure from enabled to disabled based on the indication.

Aspect 5 may be combined with any of aspects 1-4 and includes that the indication is received from the wireless device, and where the sidelink synchronization procedure is enabled or disabled based on enabling or disabling at least one of a SLSS or a S-SSB of the UE.

Aspect 6 may be combined with any of aspects 1-5 and includes that the indication corresponds to an upper layer signal that includes a field for enabling or disabling the sidelink synchronization procedure of the UE.

Aspect 7 may be combined with any of aspects 1-6 and includes that the sidelink synchronization procedure is enabled or disabled based on at least one of a timing source or a pre-configuration associated with the wireless device.

Aspect 8 may be combined with any of aspects 1-7 and includes that the indication corresponds to a MAC-CE associated with a PSSCH transmission of the wireless device.

Aspect 9 may be combined with any of aspects 1-8 and includes that the indication received from the wireless device corresponds to at least one of the SLSS or the S-SSB, and where the sidelink synchronization procedure is enabled or disabled based on at least one of a sidelink synchronization transmission resource or one or more reserved bits in a sidelink master information block (SL-MIB).

Aspect 10 may be combined with any of aspects 1-9 and includes that the indication associated with enabling or disabling the sidelink synchronization procedure is based on a location of the UE.

Aspect 11 may be combined with any of aspects 1-10 and further includes receiving a pre-configuration associated with the location of the UE, where the pre-configuration is indicative of whether the sidelink synchronization procedure is enabled or disabled based on the location of the UE.

Aspect 12 may be combined with any of aspects 1-11 and includes that the location of the UE corresponds to at least one of a zone or a zone ID indicative of whether the sidelink synchronization procedure is enabled or disabled.

Aspect 13 may be combined with any of aspects 1-12 and further includes monitoring for an ID indicative of at least one of a SLSS or a S-SSB associated with the wireless device, where the sidelink synchronization procedure is enabled or disabled based on receiving the ID associated with at least one of the SLSS or the S-SSB.

Aspect 14 may be combined with any of aspects 1-13 and includes that the ID indicative of at least one of the SLSS or the S-SSB is pre-configured at the UE.

Aspect 15 may be combined with any of aspects 1-14 and includes that the UE is a vehicular UE associated with V2X communication.

Aspect 16 is a method of wireless communication at a wireless device, including: transmitting an indication associated with enabling or disabling a sidelink synchronization procedure of a UE, where the indication is configured to trigger the enabling or disabling of the sidelink synchronization procedure of the UE; and communicating via a sidelink communication based on whether the indication triggers the enabling of the sidelink synchronization procedure of the UE or the disabling of the sidelink synchronization procedure of the UE.

Aspect 17 may be combined with aspect 16 and includes that the enabling or disabling of the sidelink synchronization procedure of the UE includes enabling or disabling transmission of at least one of a SLSS or a S-SSB from the UE.

Aspect 18 may be combined with any of aspects 16-17 and includes that transmitting the indication associated with enabling or disabling of the sidelink synchronization procedure corresponds to enabling or disabling at least one of a SLSS or a S-SSB of the UE.

Aspect 19 may be combined with any of aspects 16-18 and includes that the indication corresponds to an upper layer signal that includes a field for enabling or disabling the sidelink synchronization procedure of the UE.

Aspect 20 may be combined with any of aspects 16-19 and includes that the indication associated with enabling or disabling of the sidelink synchronization procedure is transmitted to the UE based on at least one of a timing source or a pre-configuration associated with the wireless device.

Aspect 21 may be combined with any of aspects 16-20 and includes that the indication corresponds to a MAC-CE associated with a PSSCH transmission of the wireless device.

Aspect 22 may be combined with any of aspects 16-21 and includes that the indication corresponds to at least one of the SLSS or the S-SSB, and where enabling or disabling of the sidelink synchronization procedure is triggered at the UE based on at least one of a sidelink synchronization transmission resource or one or more reserved bits in a SL-MIB.

Aspect 23 may be combined with any of aspects 16-22 and further includes transmitting an ID indicative of at least one of a SLSS or a S-SSB associated with the wireless device, where enabling or disabling of the sidelink synchronization procedure is triggered at the UE based on a transmission of the ID associated with the at least one of the SLSS or the S-SSB.

Aspect 24 may be combined with any of aspects 16-23 and includes that the ID indicative of at least one of the SLSS or the S-SSB is transmitted based on the ID being pre-configured at the UE.

Aspect 25 may be combined with any of aspects 16-24 and includes that the wireless device is an RSU.

Aspect 26 is an apparatus for wireless communication at a UE, including: a memory; and at least one processor coupled to the memory and, based at least in part on information stored in the memory, the at least one processor is configured to implement a method as in any of aspects 1-15.

Aspect 27 is an apparatus for wireless communication including means for implementing a method as in any of aspects 1-15.

Aspect 28 may be combined with any of aspects 26-27 and further includes at least one of a transceiver or an antenna coupled to the at least one processor.

Aspect 29 is a computer-readable medium (e.g., a non-transitory computer-readable medium) storing computer executable code, the code when executed by at least one processor causes the at least one processor to implement a method as in any of aspects 1-15.

Aspect 30 is an apparatus for wireless communication at a wireless device, including: a memory; and at least one processor coupled to the memory and, based at least in part on information stored in the memory, the at least one processor is configured to implement a method as in any of aspects 16-25.

Aspect 31 is an apparatus for wireless communication including means for implementing a method as in any of aspects 16-25.

Aspect 32 may be combined with any of aspects 30-31 and further includes at least one of a transceiver or an antenna coupled to the at least one processor.

Aspect 33 is a computer-readable medium (e.g., a non-transitory computer-readable medium) storing computer executable code, the code when executed by at least one processor causes the at least one processor to implement a method as in any of aspects 16-25.

What is claimed is:

1. An apparatus for wireless communication at a user equipment (UE), comprising:
a memory; and
at least one processor coupled to the memory and, based at least in part on information stored in the memory, the at least one processor is configured to:
receive an indication associated with enabling or disabling a sidelink synchronization procedure of the UE, wherein the sidelink synchronization procedure of the UE is enabled or disabled based on the indication; and
communicate with a wireless device via a sidelink communication based on whether the sidelink synchronization procedure of the UE is enabled or disabled.

2. The apparatus of claim 1, wherein the at least one processor is further configured to enable the sidelink synchronization procedure at the UE or disable the sidelink synchronization procedure at the UE based on the indication.

3. The apparatus of claim 2, wherein the sidelink synchronization procedure corresponds to transmission of at least one of a sidelink synchronization signal (SLSS) or a sidelink synchronization signal block (S-SSB) from the UE.

4. The apparatus of claim 2, wherein to enable the sidelink synchronization procedure the at least one processor is further configured to switch the sidelink synchronization procedure from disabled to enabled based on the indication, wherein to disable the sidelink synchronization procedure the at least one processor is further configured to switch the sidelink synchronization procedure from enabled to disabled based on the indication.

5. The apparatus of claim 1, wherein the indication is received from the wireless device, and wherein the sidelink synchronization procedure is enabled or disabled based on enabling or disabling at least one of a sidelink synchronization signal (SLSS) or a sidelink synchronization signal block (S-SSB) of the UE.

6. The apparatus of claim 5, wherein the indication corresponds to an upper layer signal that includes a field to enable or disable the sidelink synchronization procedure of the UE.

7. The apparatus of claim 5, wherein the sidelink synchronization procedure is enabled or disabled based on at least one of a timing source or a pre-configuration associated with the wireless device.

8. The apparatus of claim 5, wherein the indication corresponds to a medium access control (MAC) control element (CE) (MAC-CE) associated with a physical sidelink shared channel (PSSCH) transmission of the wireless device.

9. The apparatus of claim 5, wherein the indication received from the wireless device corresponds to at least one of the SLSS or the S-SSB, and wherein the sidelink synchronization procedure is enabled or disabled based on at least one of a sidelink synchronization transmission resource or one or more reserved bits in a sidelink master information block (SL-MIB).

10. The apparatus of claim 1, wherein the indication associated with enabling or disabling the sidelink synchronization procedure is based on a location of the UE.

11. The apparatus of claim 10, wherein the at least one processor is further configured to receive a pre-configuration associated with the location of the UE, wherein the pre-configuration is indicative of whether the sidelink synchronization procedure is enabled or disabled based on the location of the UE.

12. The apparatus of claim 10, wherein the location of the UE corresponds to at least one of a zone or a zone identifier (ID) indicative of whether the sidelink synchronization procedure is enabled or disabled.

13. The apparatus of claim 1, wherein the at least one processor is further configured to monitor for an identifier (ID) indicative of at least one of a sidelink synchronization signal (SLSS) or a sidelink synchronization signal block (S-SSB) associated with the wireless device, wherein the sidelink synchronization procedure is enabled or disabled based on reception of the ID associated with at least one of the SLSS or the S-SSB.

14. The apparatus of claim 13, wherein the ID indicative of at least one of the SLSS or the S-SSB is pre-configured at the UE.

15. The apparatus of claim 1, wherein the UE is a vehicular UE associated with vehicle-to-everything (V2X) communication.

16. The apparatus of claim 1, further comprising at least one of a transceiver or an antenna coupled to the at least one processor.

17. An apparatus for wireless communication at a wireless device, comprising:
a memory; and
at least one processor coupled to the memory and, based at least in part on information stored in the memory, the at least one processor is configured to:
transmit an indication associated with enabling or disabling a sidelink synchronization procedure of a user equipment (UE), wherein the indication is configured to trigger the enabling or disabling of the sidelink synchronization procedure of the UE; and
communicate via a sidelink communication based on whether the indication triggers the enabling of the sidelink synchronization procedure of the UE or the disabling of the sidelink synchronization procedure of the UE.

18. The apparatus of claim 17, wherein the enabling or disabling of the sidelink synchronization procedure of the UE includes enabling or disabling transmission of at least one of a sidelink synchronization signal (SLSS) or a sidelink synchronization signal block (S-SSB) from the UE.

19. The apparatus of claim 17, wherein transmission of the indication associated with enabling or disabling of the sidelink synchronization procedure corresponds to enabling or disabling at least one of a sidelink synchronization signal (SLSS) or a sidelink synchronization signal block (S-SSB) of the UE.

20. The apparatus of claim 19, wherein the indication corresponds to an upper layer signal that includes a field for enabling or disabling the sidelink synchronization procedure of the UE.

21. The apparatus of claim 19, wherein the indication associated with enabling or disabling of the sidelink synchronization procedure is transmitted to the UE based on at least one of a timing source or a pre-configuration associated with the wireless device.

22. The apparatus of claim 19, wherein the indication corresponds to a medium access control (MAC) control element (CE) (MAC-CE) associated with a physical sidelink shared channel (PSSCH) transmission of the wireless device.

23. The apparatus of claim 19, wherein the indication corresponds to at least one of the SLSS or the S-SSB, and wherein enabling or disabling of the sidelink synchronization procedure is triggered at the UE based on at least one of a sidelink synchronization transmission resource or one or more reserved bits in a sidelink master information block (SL-MIB).

24. The apparatus of claim 17, wherein the at least one processor is further configured to transmit an identifier (ID) indicative of at least one of a sidelink synchronization signal (SLSS) or a sidelink synchronization signal block (S-SSB) associated with the wireless device, wherein enabling or disabling of the sidelink synchronization procedure is triggered at the UE based on a transmission of the ID associated with the at least one of the SLSS or the S-SSB.

25. The apparatus of claim 24, wherein the ID indicative of at least one of the SLSS or the S-SSB is transmitted based on the ID being pre-configured at the UE.

26. The apparatus of claim 17, wherein the wireless device is a roadside unit (RSU).

27. The apparatus of claim 17, further comprising at least one of a transceiver or an antenna coupled to the at least one processor.

28. A method of wireless communication at a user equipment (UE), comprising:
receiving an indication associated with enabling or disabling a sidelink synchronization procedure of the UE, wherein the sidelink synchronization procedure of the UE is enabled or disabled based on the indication; and
communicating with a wireless device via a sidelink communication based on whether the sidelink synchronization procedure of the UE is enabled or disabled.

29. The method of claim 28, wherein the sidelink synchronization procedure corresponds to transmission of at least one of a sidelink synchronization signal (SLSS) or a sidelink synchronization signal block (S-SSB) from the UE.

30. A method of wireless communication at a wireless device, comprising:
transmitting an indication associated with enabling or disabling a sidelink synchronization procedure of a user equipment (UE), wherein the indication is configured to trigger the enabling or disabling of the sidelink synchronization procedure of the UE; and
communicating via a sidelink communication based on whether the indication triggers the enabling of the sidelink synchronization procedure of the UE or the disabling of the sidelink synchronization procedure of the UE.
